(19) United States
(12) Patent Application Publication
(10) Pub. No.: US 2011/0105676 A1
(43) Pub. Date: May 5, 2011

(54) PROCESS FOR PREPARING PLATELET-LIKE PIGMENTS COMPRISING A NITROGEN DOPED CARBON COATING

(75) Inventors: Yu Gao, Shanghai (CN); Min Yu, Shanghai (CN); Patrice Bujard, Courtepin (CH)

(73) Assignee: CIBA CORPORATION, Tarrytown, NY (US)

(21) Appl. No.: 12/673,592

(22) PCT Filed: Aug. 7, 2008
(86) PCT No.: PCT/EP08/60366

§ 371 Date: Jan. 14, 2011

(30) Foreign Application Priority Data
Aug. 20, 2007 (EP) 07114616.1

(51) Int. Cl. C08L 39/06; C08L 33/20; C08L 75/04

(52) U.S. Cl. 524/548; 524/565; 524/612; 524/590

(57) ABSTRACT

The invention relates to a process for preparing platelet-like pigments comprising a core and at least one coating layer consisting essentially of a compound having from 60 to 95% by weight of carbon and from 5 to 25% by weight of nitrogen, the balance to 100% being selected from elements of the group consisting of hydrogen, oxygen and sulfur, comprising the steps of: (a) suspending plateletlike particles in a liquid; (b) adding one or more polymers containing nitrogen and carbon atoms, or (a1) suspending one or more polymers containing nitrogen and carbon atoms in a liquid; (b1) adding the plateletlike particles, (c) effecting a polymeric coating layer to be formed on the surface of said plateletlike particles from the polymers added at step (b), or (a1); (d) isolating said plateletlike particles having said polymeric coating layer from the suspension; and (e) heating said plateletlike particles having said polymeric coating layer to a temperature of from 100° C. to 1000° C. in a gaseous environment, to the pigments obtained by the method and the use thereof. It is possible by the process of the present invention to obtain very regular, homogeneous and continuous coatings in an extremely wide range of thicknesses.

The present invention relates to a process for preparing platelet-like pigments comprising a core and at least one coating layer consisting essentially of a compound having from 60 to 95% by weight of carbon and from 5 to 25% by weight of nitrogen, the balance to 100% being selected from elements of the group consisting of hydrogen, oxygen and sulfur and to the pigments obtained by the method and the use thereof.

The preparation of fine black pigments through oxydative pyrolysis at 200-350° C. of acrylonitrile-based polymer particles treated with an adhering aminosiloxane is disclosed in JP-63/142066-A. This process leads to an uniformly shaped black powder, which contains only traces of nitrogen and does not produce any luster effect or goniochromaticity.

DD 238 994 discloses organophilic colored fillers consisting of small clay or kaolin particles (Ø≦2 μm) embedded in a matrix based on conducting polymers, which are obtained by calcination of a ceramic mass of clay and a polymer such as acrylonitrile at a temperature between 150° C. and 50° C. below the clay's decomposition point. Yet, these composite fillers are of brown to black color, without any luster effect or goniochromaticity, and their components are not arranged regularly.

DD 238 993 discloses organophilic colored fillers consisting of small clay or kaolin particles (Ø≦2 μm) embedded in a matrix containing amorphous carbon, which are obtained by calcination of a ceramic mass of clay and a polymer such as acrylonitrile at a temperature above the clay's decomposition point. Additional components such as mica may be contained in amounts up to 20% by weight. Yet, these composite fillers are of brown to black color, without any luster effect or goniochromaticity, and their components are not arranged regularly.

U.S. Pat. No. 5,322,561 relates to conductive flaky pigments, the conductive coating of which consists of a metal oxide pigment layer doped with additional metal oxide particles and containing interdispersed carbon black particles. The color is however black to pale and silvery grey, with quite a low chroma.

U.S. Pat. No. 3,087,827 discloses the deposition of carbon onto a TiO₂ layer from hydrocarbons, fatty acids, fats or soaps at 700-1000° C. The carbon fills into the minute spaces between the TiO₂ particles, even when deposited at the end of the process. Total absence of oxygen is required in order to avoid undesirable soot or particulate carbon formation. Moreover, the products are insatisfactory light stable as is known from U.S. Pat. No. 5,501,731.

U.S. Pat. No. 5,271,771 discloses carbon-containing effect pigments which are obtained through simultaneous deposition of carbon and a metal on a plate-like substrate, and subsequent redox reaction between the metal oxide in the pigment's undercoat and the metal in the pigment's topcoat, together with precipitation of carbon, at high temperatures under reducing conditions. It is however not possible to deposit the carbon-containing layer without altering the system's optical properties.

Dark effect pigments are known from DE-OS 195 02 231, which are coated with carbon black embedded in or overlaid with titanium oxide. They are obtained by coating a plateletlike core mechanically with carbon black particles, precipitating thereon titanium hydroxide and a metallic reducing agent, and pyrolizing the obtained composite at about 500-1000° C. under inert conditions. The chroma is somewhat improved but at the detriment of the lightness which is much too low.

U.S. Pat. No. 4,076,551 discloses pigments coated with a metal hydroxide or bismuth oxychloride layer and carbon black particles incorporated therein. Example 3 discloses a blue mica/TiO₂ interference pigment coated with 3% of carbon black and 0.73% Al₂O₃, which exhibits a strong dark blue powder color with a lively blue shimmer and may be heated to 300° C. for 40 minutes without any gloss or color change. However, the amount of carbon which can be fixed is limited and depends on the pigment's available surface area. For mica flakes, it does not exceed about 15 mg/m², the carbon in excess remaining in suspension and affecting the luster. In addition, it is very difficult to disperse the carbon black in aqueous media, and the coating is irregular, so that the color and the goniochromaticity do not meet today's requirements to a satisfactory extent.

U.S. Pat. No. 5,501,731 claims that some of above lacks may be solved by coating plateletlike silicatic substrates with carbon-containing metal compounds (such as Cr^{III}acac₃) and compounds of the formula [(CH₂O)₁₋₆]ₓ (such as sugars or starch), and then decomposing the carbon-containing compounds on the surface of the substrate particles under oxygen-excluding conditions. Very smooth coatings can allegedly be obtained when the decomposition takes place from the gas phase. However, this process leads to coatings containing high amounts of a metal—the ratio Cr/C is 0.92 in example 1 and 1.50 in example 2. Consequently, it is only suitable for very thin layers, generally 1-20 nm, preferably 1-10 nm. Furthermore, a substantial amount of the metal is detached from the coating upon thermal decomposition, leading to a highly undesirable contamination with metallic particles which affect the coloristic properties and can be abrasive or develop an undesired catalytic activity when the pigment is incorporated into a high molecular weight organic material.

U.S. Pat. No. 5,364,467 and U.S. Pat. No. 5,662,738 finally disclose luster pigments based on plateletlike metallic substrates comprising a first layer of metal oxide, a second, nonselectively absorbing layer of carbon, metal or metal oxide, and optionally a third layer of metal oxide. There is however no example wherein the second layer is carbon. Notwithstanding the statement that a carbon layer may be made by thermal decomposition of a compound containing at least 1 oxygen for every 2 carbon atoms (such as PVA, sorbitol or sugars), this method does not enable to make regularly coated, isolated particles. Instead, very irregularly coated particles are obtained together with agglomerates which consist of several platelets linked together at different dihedric angles by a bridging carbonaceous mass.

US2006292371 discloses pigments comprising an effect pigment substrate having a carbon-containing organic coating thereon, said organic coating comprising a carbon-containing ionic species.

The pigments are obtained by a method comprising coating a platy pigment substrate with at least one carbon-containing ionic species or alternating layers of oppositely charged carbon-containing ionic species, treating the coating to generate a carbon coating on said substrate. Preferably said substrate is coated with at least one alternating sequence of polydiallyldimethyl ammonium chloride and poly(sodium 4-styrene sulfonate).

DE4317019 discloses surface-modified nacreous pigments which are coated with 0.5-20% of a polymer compound of formula —(CH₂—CM¹M²)ₙ-, or —(—O—(CH₂)ₓ—O—CO—NH—(CH₂)_{y}—NH—CO—)—ₙ, or an optionally substituted melamine resin, wherein M¹ is H, C₁₋₁₀alkyl, —COOR, —NH₂, —COOH or —CONH₂; M² is H or C₁₋₁₀alkyl; R is C₁₋₁₀alkyl; x and y are 1-10; n>1000. In Example 1 of DE4317019 Fe₂O₃ coated mica is dispersed in toluene and polyethylene wax is added and the dispersion is heated under reflux. The polyethylene wax coated pigment is separated and is dried at 80° C. for 2 hours.

50 g Iriodin 504 (mit beschichtetes Glimmerpigment der Teilchengrösse 10-60 mu m der Fa. E. Merck, Darmstadt) werden in 300 ml Toluol suspendiert and mit 5 g Polyethylenwachs (Molmasse ca. 10000) versetzt. Die Suspension wird 0.5 h unter Rückfluss gekocht, wobei das Polyethylenwachs schmilzt. Beim Erkalten der Suspension adsorbiert das Polyethylenwachs auf dem Pigment. Das beschichtete Pigment wird abgesaugt and bei 80 DEG C 2 h getrocknet.

U.S. Pat. No. 6,436,538 relates to a collection of composite plateletlike particles comprising a core and at least one coating layer consisting essentially of a compound having from 60 to 95% by weight of carbon and from 5 to 25% by weight of nitrogen, the balance to 100% being selected from elements of the group consisting of hydrogen, oxygen and sulfur. Preferably, the process for preparing the instant collection of particles comprises the steps of

(a) suspending plateletlike particles in a liquid;
(b) optionally adding a surface modifier, a polymerisation catalyst or both;
(c) before or after step (b), adding one or more monomers which are capable to polymerize to polymers containing nitrogen and carbon atoms;
(d) effecting a polymeric coating layer to be formed on the surface of said plateletlike particles from the monomers added at step (c);
(e) isolating said plateletlike particles having said polymeric coating layer from the suspension; and
(f) heating said plateletlike particles having said polymeric coating layer to a temperature of from 100° C. to 1000° C. in a gaseous environment.

The polymer is preferably a polypyrrole, a polyamide, a polyaniline, a polyurethane, a nitrile rubber or a melamin-formaldehyde resin and is preferably formed “in situ” from monomers while effecting a polymeric coating layer to be formed on the surface of said plateletlike particles. By this method irregularly coated particles are obtained.

Consequently, the coloristic properties of these luster pigments are still not satisfactory.

The instant invention's object is to provide effect pigments that meet today's requirements to an especially high degree even in high-quality applications. The effect pigments according to the invention posses superior optical properties, such as high reflectivity, brilliance, luster and opacity. Those of the instant effect pigments which are coloured display a high chroma coupled with interesting flop effects (colour travel), for example goniochromaticity. Their outstanding light stability and chemical and mechanical properties render them particularly suitable for use in all customary kind of substrates, including water-based coating systems, wherein there is surprisingly no need for an additional stabilizing treatment even in the case of metallic cores.

Said object has been solved by a process for preparing platelet-like pigments comprising a core and at least one coating layer consisting essentially of a compound having from 60 to 95% by weight of carbon and from 5 to 25% by weight of nitrogen, the balance to 100% being selected from elements of the group consisting of hydrogen, oxygen and sulfur, comprising the steps of:
(a) suspending plateletlike particles in a liquid;
(b) adding one or more polymers containing nitrogen and carbon atoms, or
   (a1) suspending one or more polymers containing nitrogen and carbon atoms in a liquid;
   (b1) adding the plateletlike particles,
(c) effecting a polymeric coating layer to be formed on the surface of said plateletlike particles from the polymers added at step (b), or (a1);
(d) isolating said plateletlike particles having said polymeric coating layer from the suspension; and
(e) heating said plateletlike particles having said polymeric coating layer to a temperature of from 100° C. to 1000° C. in a gaseous environment.

The platelet-like pigments are new and form a further object of the present invention. Accordingly, the present invention is also directed to platelet-like pigments comprising a core and at least one coating layer consisting essentially of a compound having from 60 to 95% by weight of carbon and from 5 to 25% by weight of nitrogen, the balance to 100% being selected from elements of the group consisting of hydrogen, oxygen and sulphur, obtainable according to the process of the present invention.

Said coating is hereafter also referred to as a nitrogen doped carbon coating.

The compound's carbon content is preferably from 70 to 90% by weight. The hydrogen content is preferably from 0.5 to 5% by weight. The nitrogen content is preferably from 13 to 22% by weight. The sulfur content is preferably below 1% by weight, most preferably nil. While each core is preferably surrounded by one nitrogen doped carbon coating, it can also be surrounded by two or more of said coatings.

The pigments of the present invention can be used in paints, ink-jet printing, for dyeing textiles, for pigmenting coatings, printing inks, plastics, cosmetics, glazes for ceramics and glass. Accordingly, paints, printing inks, plastics, cosmetics, ceramics and glass, which are pigmented with a pigment according to the present invention form a further subject of the present invention.

Suitable platelet-shaped substrates (=core) are transparent, partially reflectant, or reflectant. Examples thereof are natural micaceous iron oxide (for example as in WO99/48634), synthetic and doped micaceous iron oxide (for example as in EP-A-068311), mica (biotite, vermiculite, sericite, muscovite, phlogopite, fluorophlogopite, kaolinite or related), or any synthetic mica, such as synthetic fluorophlogopite, basic lead carbonate, flaky barium sulfate, MoS₂, SiO₂, Al₂O₃, TiO₂, glass, ZnO, ZrO₂, SnO₂, BiOCl, chromium oxide, BN, MgO flakes, Si₃N₄, and graphite. Particularly preferred substrates are natural, or synthetic mica, SiO₂ flakes, Al₂O₃ flakes, TiO₂ flakes, and glass flakes.

Another preferred embodiment is the use of flat metallic particles as the core. Examples of suitable metallic particles are flakes of Ag, Al, Au, Cu, Cr, Fe, Ge, Mo, Ni, Si, Ti, or alloys thereof, such as brass or steel, preferably Al flakes. Depending on the material, a natural optically non-interfering oxide layer may form on the surface of metallic particle. Partially reflecting cores have preferably a reflectance of at least 35% of the light falling vertically on its surface in the range from 380 to 800 nm.

Additional examples of plateletlike substrates are plateletlike organic pigments, such as chinacridones, phthalocyanine, fluororubine, red perylenes or diketopyrrolopyrroles.

The instant pigments preferably also comprise an intermediate coating between the core and the nitrogen doped carbon coating, which intermediate coating may consist, for example, of one or more layers of Prussian blue, MgF₂ or, especially, of a metal or mixed-metal oxide or oxide hydrate. The intermediate layer has preferably a thickness of from 0.01 to 1 μm. Such pigments are well known to the person skilled in the art. Examples thereof are pearlescent pigments (including those which react under the fluidized bed conditions to nitrides, oxynitrides or by reduction to suboxides etc.) (for example EP-A-0948571, EP-A-1028146, EP-A-0763573, U.S. Pat. No. 5,858,078, WO98/53012, WO97/43348, U.S. Pat. No. 6,165,260, DE-A-1519116, WO97/46624); pearlescent multilayer pigments (for example EP-A-0948572, EP-A-0882099, U.S. Pat. No. 5,958,125, U.S. Pat. No. 6,139,613), especially titanium oxide-coated mica platelets are also commercially available unter the names Iriodin® (E. Merck, Darmstadt), Flonac® (Kemira Oy, Finland), Mearlin® (Mearl Corporation, New York/USA) and Infinite Color® (Shisheido, Japan), and coated metal flakes, such as, for example, titanium dioxide or silicon dioxide coated metal flakes (for example WO0043457, U.S. Pat. No. 5,091,010 and EP717453). The size of the core particles is not critical per se and can be adapted to the particular use. Generally, the particles have a length from about 1 to 200 μm, in particular from about 5 to 100 μm, and thicknesses from about 0.05 to 5 μm, preferably from 0.1 to 2 μm. Particles having a platelet-like shape are understood to be such having two essentially flat and parallel surfaces, with an aspect ratio (length to thickness) of from about 2:1 to about 1000:1, and a length to width ratio of from 3:1 to 1:1.

On transparent core particles having a low refractive index, the intermediate layer consists preferably of a metal oxide, oxide hydrate or halide such as titanium, zirconium, tin, iron, chromium or zinc oxide, bismuth oxychloride or mixtures thereof, on top which an optional protective layer may preferably also be applied to increase the stability, for example a layer of a metal oxide such as silicon or aluminium oxide. Of particular importance are micas, which are coated with highly refractive colorless metal oxides or oxide hydrates. Particularly preferred are intermediate coatings of zirconium dioxide or titanium dioxide; very particularly preferred is a coating of titanium dioxide. A very particular interest is given to micas having a dielectric coating layer of thickness from 0.03 to 0.3 μm.

The intermediate coating layer may also consist of a pack of multiple layers, for example from 2 to 20 layers. If desired, a layer of a colorless metal oxide or oxide hydrate can for example be combined with a layer of a colored metal oxide or oxide hydrate. Alternatively, layers having a high refractive index (≧2.0) and layers having a low refractive index (≦2.0) may be alternated.

On metallic flakes, the intermediate layer consists preferably of a metal oxide, oxide hydrate or halide such as titanium, zirconium, tin, iron, chromium or zinc oxide, bismuth oxychloride or mixtures thereof. Particularly preferred is a coating of silicon dioxide.

The nitrogen doped carbon coating has for example a thickness of from 1 nm to 1 μm, preferably of from 1 nm to 300 nm. Further preferences for particular coating compounds are given below.

Above the nitrogen doped carbon coating, the instant effect pigments may optionally also be coated with an outer coating, which may consist of one or more layers of various materials according to the function to be performed. For example, the outer coating may consist of a transparent or selectively absorbing dielectric material of any kind, the specific electrical resistance of which according to the customary definition is at least 10¹⁰ Ω·cm.

Where appropriate, the outer coating preferably consists of a metal oxide, oxide hydrate or metal fluoride, for example of TiO₂, ZrO₂, SiO, SiO₂, SnO₂, GeO₂, ZnO, Al₂O₃, V₂O₅, Fe₂O₃, Cr₂O₃, MgO, MgF₂, CuO or PbTiO₃, or a mixture thereof. The outer coating may protect the underlying coatings from chemical or mechanical influences. In this case, its refractive index is preferably as similar as possible to that of the external medium in which the pigment is intended to be embedded. Particularly preferred, the outer coating has a refractive index of from 1.33 to 1.71, although materials having high refractive indices may also be used. The thickness of a protective outer coating is most adequately no greater than 200 nm, preferably no greater than 100 nm, especially no greater than 50 nm.

The outer coating may, however, also reflect part of the incident light, or refract the incident light and the light reflected by the core, generating interference effects. In this case, its refractive index is preferably as high as possible, for example above 2.0. The thickness of a reflective outer coating is most adequately from 100 to 400 nm.

Of course, the outer coating may also consist of multiple layers, for example such as described above for the intermediate coating. When the outer coating consists of more than one layer, then it is preferably composed of alternate layers of a dielectric material and an instant nitrogen doped carbon coating or a semitransparent metal coating.

Pigments having the following layer structure are especially preferred:

| | | | |
|---|---|---|---|
| TRASUB | TiO₂ | | |
| TRASUB | Fe₂O₃ | | |
| TRASUB | TiO₂/Fe₂O₃ | | |
| TRASUB | TiO₂ | Fe₂O₃ | |
| TRASUB | TiO₂ | SiO₂ | TiO₂ |
| TRASUB | TiO₂ | SiO₂ | TiO₂/Fe₂O₃ |
| TRASUB | Cr₂O₃ | SiO₂ | TiO₂ |
| TRASUB | Fe₂O₃ | SiO₂ | TiO₂ |
| TRASUB | TiO suboxides | SiO₂ | TiO₂ |
| TRASUB | TiO₂ | SiO₂ | TiO suboxides |
| TRASUB | Fe₂TiO₅ | | |
| TRASUB | STL | TiO₂ | |

wherein TRASUB is a transparent, or semitransparent platelet-like substrate having a low index of refraction, especially natural, or synthetic mica, another layered silicate, glass, Al₂O₃, SiO_{z} especially SiO₂, SiO₂/SiOₓ/SiO₂ (0.03≦x≦0.95), SiO_{1.40-2.0}/SiO_{0.70-0.99}/SiO_{1.40-2.0}, or Si/SiO_{z} with 0.70≦z≦2.0, especially 1.40≦z≦2.0, and
STL is a semi-transparent layer, such as, for example, a semi-transparent metal layer of Cu, Ag, Cr, or Sn, or a semitransparent carbon layer.

Preferably, the process of the present invention comprises the steps of:
(a1) suspending one or more polymers containing nitrogen and carbon atoms in a liquid;
(b1) adding the plateletlike particles,
(c) effecting a polymeric coating layer to be formed on the surface of said plateletlike particles from the polymers added at step (a1);
(d) isolating said plateletlike particles having said polymeric coating layer from the suspension; and
(e) heating said plateletlike particles having said polymeric coating layer to a temperature of from 100° C. to 1000° C. in a gaseous environment.

With this process, it is surprisingly possible to form very consistent, regular nitrogen doped carbon coatings of thickness from 1 nm to 1 μm, preferably from 1 nm to 300 nm.

The polymer containing nitrogen and carbon atoms has preferably unsaturated bonds. Examples are a polypyrrole, a polyamide, a polyaniline, a polyurethane, a nitrile rubber or a melamin-formaldehyde resin, which may be used alone in mixtures together with other polymers, such as polythiophene, polyacetylene, polyparaphenylene or polyparaphenylene-sulphide. Preferred polymers are homo- and copolymerisates of acrylonitrile, acrylamide, methacrylonitrile, methacrylamide, crotononitrile and crotonamide, such as, most preferred, polyacrylonitrile. The one, or more polymers are preferably selected from polyvinylpyrrolidone (Mw=50,000-80,000), polyacrylonitrile (Mw=50,000-200,000), polyaniline (5,000-10,000), and polyurethane (30,000-50,000). Most preferred is polyacrylonitrile (Mw=50,000-150,000).

The used liquid (solvent) depends on the polymer of choice and can be, for example, distilled water, N′N-dimethyl acetamide (DMAC), N,N′-dimethyl formamide (DMF), or a mixture thereof.

In case of polyacrylonitrile the liquid is preferably DMAC and DMF, wherein DMAC is most preferred. In case of polyvinylpyrrolidone the liquid is preferably water. The amount of liquid is not critical at all, and may vary for example from 1 to 1000 parts by weight, based on the weight of the plateletlike particles.

Polar polymers may be deposited before the nitrogen containing polymer, or in admixture with said polymer. Suitable polar polymers are for example compounds having a molecular weight (M_{w}) of from about 1000 to about 100000 and repeating units carrying polar groups, such as polyvinyl alcohol, cellulose or derivatives thereof. Most preferred are polyvinyl alcohol derivatives, for example a polyvinyl alcohol with sulfonate or silanol groups, and cellulose derivatives, for example carboxymethylcellulose or cellulose thiocarbonate.

In step (a1) the polymer containing nitrogen and carbon atoms is suspended, or dissolved in a liquid. In step (b1) the plateletlike particles are added.

Effecting the polymeric coating layer to be formed is performed in analogy to methods which are known per se. The polymer containing nitrogen and carbon atoms (and optionally the polar polymers) may for example be coated by simply stirring at a temperature of from 0 to 100° C., especially 40 to 80° C.

Isolating the coated particles is done by standard methods, such as for example filtrating or centrifugating, then washing the residue with a common solvent or with water and drying, for example batchwise in an oven or continuously in a spray-dryer.

The coated particles are then preferably heated to a temperature of from 100° C. to 1000° C. in a gaseous environment. The preferred temperature range is from 150 to 600° C. In this step, most hydrogen atoms and hydroxy groups are eliminated, and the coating gets a high degree of unsaturation and crosslinking, as well as a very dark color. In an ideal case, the whole coating around each core becomes completely unsaturated, with as much conjugated double bonds as possible. Generally, the temperature suitable for obtaining this result is known for the bulk nitrogen containing polymers or might be chosen in analogy thereto for related materials.

The gaseous environment ensures that there is a minimum of contact between the particles during step (e). It is preferred to slightly agitate the particles, for example in a fluidized bed, in order that gravity does not cause them to stick together. The gas to be used depends on the temperature and should not induce a reduction. It is preferred to use an oxygen-containing gas, such as air, at temperatures of from 100° C. to 300° C., and inert gasses, such as nitrogen or argon, at temperatures from about 200 to 1000° C. If the temperature should exceed 300° C., then it is preferred to heat in 2 steps, an oxygen-containing gas being used up to a temperature of from 200 to 300° C., and an inert gas afterwards when the temperature is increased above it.

In a preferred embodiment of the present invention the plateletlike particles are heated in step e) to a temperature of from 200-600° C., especially of from 250-400° C.

Interference pigments with enhanced chroma can be obtained, if the plateletlike particles are heated in step e) in an oxygen containing atmosphere, such as air, to a temperature of from 200-300° C., especially of from 240-280° C. for a time of from 1 to 4 h, especially about 2 h.

The duration of the heat treatment depends on the coating's chemical constitution as well as from the equipment to be used. It may vary from as short as a few seconds (such as 10 s) to a few days (such as 1 week). Preferably, for batch operations reaction times from ½ to 30 h are chosen, reaction times from 1 to 10 h being most preferred.

Surprisingly, it has been found, that it is possible to obtain very regular, homogeneous and continuous coatings in an extremely wide range of thicknesses.

The (effect, or interference) pigments according to the invention can be used for all customary purposes, for example for colouring polymers in the mass, coatings (including effect finishes, including those for the automotive sector) and printing inks (including offset printing, intaglio printing, bronzing and flexographic printing), and also, for example, for applications in cosmetics, in ink-jet printing, for dyeing textiles, glazes for ceramics and glass as well as laser marking of papers and plastics. Such applications are known from reference works, for example “High Performance Pigments” (H. M. Smith, Wiley VCH-Verlag GmbH, Weinheim, 2002), and “Special effect pigments” (R. Glausch et al., Curt R. Vincentz Verlag, Hannover, 1998).

When the pigments according to the invention are interference pigments (effect pigments), they may be goniochromatic and result in brilliant, highly saturated (lustrous) colours. They are accordingly very especially suitable for combination with conventional, transparent pigments, for example organic pigments such as, for example, diketopyrrolopyrroles, quinacridones, dioxazines, perylenes, isoindolinones etc., it being possible for the transparent pigment to have a similar colour to the effect pigment. Especially interesting combination effects are obtained, however, in analogy to, for example, EP-A-388 932 or EP-A-402 943, when the colour of the transparent pigment and that of the effect pigment are complementary.

Accordingly, the present invention is also directed to the use of the pigments of the present invention in paints, ink-jet printing, for dyeing textiles, for pigmenting coatings, printing inks, plastics, cosmetics, glazes for ceramics and glass and paints, printing inks, plastics, cosmetics, ceramics and glass, which are pigmented with a pigment according to the present invention.

The (effect) pigments according to the invention can be added in any tinctorially effective amount to the high molecular weight organic material being pigmented. A pigmented substance composition comprising a high molecular weight organic material and from 0.01 to 80% by weight, preferably from 0.1 to 30% by weight, based on the high molecular weight organic material, of an pigment according to the invention is advantageous. Concentrations of from 1 to 20% by weight, especially of about 10% by weight, can often be used in practice.

High concentrations, for example those above 30% by weight, are usually in the form of concentrates (“masterbatches”) which can be used as colorants for producing pigmented materials having a relatively low pigment content, the pigments according to the invention having an extraordinarily low viscosity in customary formulations so that they can still be processed well.

For the purpose of pigmenting organic materials, the effect pigments according to the invention may be used singly. It is, however, also possible, in order to achieve different hues or colour effects, to add any desired amounts of other colour-imparting constituents, such as white, coloured, black or effect pigments, to the high molecular weight organic substances in addition to the effect pigments according to the invention. When coloured pigments are used in admixture with the effect pigments according to the invention, the total amount is preferably from 0.1 to 10% by weight, based on the high molecular weight organic material. Especially high goniochromicity is provided by the preferred combination of an effect pigment according to the invention with a coloured pigment of another colour, especially of a complementary colour, with colorations made using the effect pigment and colorations made using the coloured pigment having, at a measurement angle of 10°, a difference in hue (ΔH*) of from 20 to 340, especially from 150 to 210.

The pigmenting of high molecular weight organic substances with the pigments according to the invention is carried out, for example, by admixing such a pigment, where appropriate in the form of a masterbatch, with the substrates using roll mills or mixing or grinding apparatuses. The pigmented material is then brought into the desired final form using methods known per se, such as calendering, compression moulding, extrusion, coating, pouring or injection moulding. Any additives customary in the plastics industry, such as plasticisers, fillers or stabilisers, can be added to the polymer, in customary amounts, before or after incorporation of the pigment. In particular, in order to produce non-rigid shaped articles or to reduce their brittleness, it is desirable to add plasticisers, for example esters of phosphoric acid, phthalic acid or sebacic acid, to the high molecular weight compounds prior to shaping.

For pigmenting coatings and printing inks, the high molecular weight organic materials and the effect pigments according to the invention, where appropriate together with customary additives such as, for example, fillers, other pigments, siccatives or plasticisers, are finely dispersed or dissolved in the same organic solvent or solvent mixture, it being possible for the individual components to be dissolved or dispersed separately or for a number of components to be dissolved or dispersed together, and only thereafter for all the components to be brought together.

Dispersing an effect pigment according to the invention in the high molecular weight organic material being pigmented, and processing a pigment composition according to the invention, are preferably carried out subject to conditions under which only relatively weak shear forces occur so that the effect pigment is not broken up into smaller portions.

Plastics comprising the pigment of the invention in amounts of 0.1 to 50% by weight, in particular 0.5 to 7% by weight. In the coating sector, the pigments of the invention are employed in amounts of 0.1 to 10% by weight. In the pigmentation of binder systems, for example for paints and printing inks for intaglio, offset or screen printing, the pigment is incorporated into the printing ink in amounts of 0.1 to 50% by weight, preferably 5 to 30% by weight and in particular 8 to 15% by weight.

The effect pigments according to the invention are also suitable for making-up the lips or the skin and for colouring the hair or the nails.

The invention accordingly relates also to a cosmetic preparation or formulation comprising from 0.0001 to 90% by weight of a pigment, especially an effect pigment, according to the invention and from 10 to 99.9999% of a cosmetically suitable carrier material, based on the total weight of the cosmetic preparation or formulation.

Such cosmetic preparations or formulations are, for example, lipsticks, blushers, foundations, nail varnishes and hair shampoos.

The pigments may be used singly or in the form of mixtures. It is, in addition, possible to use pigments according to the invention together with other pigments and/or colorants, for example in combinations as described hereinbefore or as known in cosmetic preparations.

The cosmetic preparations and formulations according to the invention preferably contain the pigment according to the invention in an amount from 0.005 to 50% by weight, based on the total weight of the preparation.

Suitable carrier materials for the cosmetic preparations and formulations according to the invention include the customary materials used in such compositions.

The cosmetic preparations and formulations according to the invention may be in the form of, for example, sticks, ointments, creams, emulsions, suspensions, dispersions, powders or solutions. They are, for example, lipsticks, mascara preparations, blushers, eye-shadows, foundations, eyeliners, powder or nail varnishes.

The cosmetic preparations and formulations according to the invention are prepared in conventional manner, for example by mixing or stirring the components together, optionally with heating so that the mixtures melt.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

The analytical samples for measuring the hue-value h and the saturation C* and also the hiding power ΔE*-S/W are prepared according to DIN 53 775 part 7 using pressed PVC plates (1 mm thick) containing 1.0% by weight of the interference pigment.

The hiding power ΔE*-S/W is measured according to DIN 55984.

All colour measurements in remission/transmission are effected using a Minolta CM 3610d spectrophotometer (d/8 geometry, including the gloss, illuminant D65, observer 2°& 10° and B&W Leneta cards. All “angle-depending” measurements are effected using a Datacolor FX 10 and B&W Leneta cards.

### Example 1

0.04 g polyacrylonitrile (PAN) are dissolved in 50 ml N′N-dimethyl acetamide (DMAC). 10 g XYMARA D05 effect pigment are suspended in the obtained PAN-DMAC solution for 1 hr at 60° C. Then the solvent is evaporated and the obtained flakes are heated at 260° C. for 2 hours under air in a muffle oven. The dry powder of the pigment obtained contains 0.30% of carbon and shows golden interference color.

### Example 2

A polyacrylonitrile coating is prepared according to example 1 except XYMARA D05 is replaced by XYMARA D15. The dry powder of the pigment obtained after pyrolysis contains 0.3% of carbon and shows red interference color.

### Example 3

10 g XYMARA D25 effect pigment are suspended in 100 ml of 0.1 wt % aqueous polyvinylpyrrolidone (PVP) solution for 1 hr at room temperature. Then the solvent is evaporated and the obtained flakes are heated at 260° C. for 1 hour under air in a muffle oven. The dry powder of the pigment obtained contains 0.28% of carbon and shows blue interference color.

### Comparative Example 1

### In Analogy to Example 1 of U.S. Pat. No. 6,436,538

10 g XYRAMA D05 are suspended in 150 ml of 0.1M aqueous solution of citric acid for 1 hr at 50° C. to obtain the adsorbed citric acid on the surface of D05 flake substrates. After separation of the flakes from the suspension, the flakes are washed thoroughly with water and suspended again in 150 ml of 0.015M aqueous solution of sodium dodecyl sulfate at 50° C. The pH of the suspension is adjusted to 2.0 with 1M aqueous HNO₃ and 0.1 g acrylonitrile are added. 1 ml of a 0.2 M ceric ammonium nitrate solution in 0.05 M HNO₃ are added drop wise to the suspension under nitrogen. The polymerization of acrylonitrile is allowed to proceed at 50° C. under nitrogen atmosphere for 6 hours. After that, the flakes are washed with water, methanol and then three times with N,N-dimethylformamide to remove ungrafted polyacrylonitrile. The polyacrylonitrile-coated coated flakes are then heated at 260° C. for 2 hours under air.

The final product contains 0.30% of carbon and has an intense golden interference color. The carbonized polymer coating of the interference pigment of Comparative Example 1 is not as smooth as in case of the interference pigments of Examples 1 to 3.

### Application Example 1

### Millbase

| Product | % by wt. |
|---|---|
| 1-Butanol | 4.00 |
| Baysilone MA | 0.035 |
| Buylglycolacetate | 4.00 |
| Setal 84XX-70 | 42.93 |
| Setamine US138BB70 | 16.66 |
| Solvesso 100 | 32.36 |
| Sum | 99.99 |

### Let Down:

| Product | % by wt. |
|---|---|
| 1-Butanol | 5.14 |
| Baysilone MA | 0.045 |
| Buylglycolacetate | 2.57 |
| Setal 84XX-70 | 55.06 |
| Setamine US138BB70 | 21.39 |
| Solvesso 100 | 15.79 |
| Sum | 100.00 |

Millbase and Let Down are mixed well in a ratio of 30:70. 0.2 g of the interference pigment and 9.8 g of the blend are continuously stirred on a magnet stirrer. The resin/pigment dispersion is drawn down onto a Leneta black and white chart (panel) from the Leneta Company using a wet film applicator. The film is flashed in a flash cabinet for 30 minutes and then “baked” in an oven at 130° C. for 30 minutes.

Colour characteristic variations at 15° of drawdowns of the pigments obtained in examples 1, 2 and 3 as well as comparative example 1 (CIELAB—ΔL, ΔC, Δh) above a black background are shown in the table below. A drawdown containing the interference pigment without carbonized polymer coating is used as standard.

| Colour data at 15° | ΔL | ΔC | ΔH |
|---|---|---|---|
| Pigment of Example 1 | −1.92 | 4.88 | −1 |
| Pigment of Comparative | −10.08 | 2.13 | −2.04 |
| Example 1 | | | |
| Pigment of Example 2 | −3.14 | 5.25 | −0.73 |
| Pigment of Example 3 | −3.87 | 8.80 | 0.36 |

As evident from the table the chroma of the interference pigments of the present invention is increased as compared to the standard and to the pigment of the Comparative example.

### Application Example 2

0.8 g of the interference pigment are mixed with 63.5 g polyvinyl chloride (PVC Evipol SH 7020, EVC GmbH, Frankfurt a.M), 33.5 g of VESTINOL DZ (DIDP) Plasticiser and 1.5 g REOPLAST 39, 1.30 g heat stabilisers based on barium zinc carboxylate IRGASTAB BZ 561 (BaZn) and 0.20 g of UV absorber TINUVIN 320.

After a wetting time of 30 minutes, the mixture is processed on a roll mill for 8 minutes at a roll temperature of 160° C. to a PVC film.

Colour characteristic variations at 15° of the PVC film containing the pigments obtained in examples 1, 2 and 3, respectively (CIELAB—ΔL, ΔC, Δh) above a white background are shown in the table below. A PVC containing the interference pigment without carbonized polymer coating is used as standard.

| Colour data at 15o | ΔL | ΔC | ΔH |
|---|---|---|---|
| Pigment of Example 1 | −10.52 | 10.78 | −2.10 |
| Pigment Example 2 | −6.17 | 11.38 | 2.36 |
| Pigment of Example 3 | −7.86 | 9.47 | −1.43 |

As evident from the table the chroma of the interference pigments of the present invention is increased as compared to the standard

### Methylene Blue Test

The photocatalytic activity of the carbonized polymer coated interference pigments of Examples 1 to 3 is evaluated by photo-degradation of methylene blue: 50 mg of effect pigment in 5 g water are stirred by a magnetic stirrer in the presence of 1 drop of methylene blue solution and exposed to light. A comparison sample, comprising the corresponding interference pigments without carbonized polymer coating, is prepared and agitated at the same time under light exclusion. Colour changes of the samples are evaluated each half hour (4×) with regard to the comparison sample.

The above test reveals that the methylene blue solution containing the interference pigment without carbonized polymer coating changes color within 15 minutes. While the methylene blue solution containing the interference pigments with carbonized polymer coating don't show any color change after 2 hours of exposition to UV light.

1. A process for preparing platelet-like pigments comprising a core and at least one coating layer said coating layer consisting essentially of a compound having from 60 to 95% by weight of carbon and from 5 to 25% by weight of nitrogen, the balance to 100% being selected from elements of the group consisting of hydrogen, oxygen and sulfur, comprising the steps of:
(a) suspending plateletlike particles in a liquid;
(b) adding one or more polymers containing nitrogen and carbon atoms, or
(a1) suspending one or more polymers containing nitrogen and carbon atoms in a liquid;
(b2) adding the plateletlike particles,
(c) effecting a polymeric coating layer to be formed on the surface of said plateletlike particles from the polymers added at step (b) or (a1);
(d) isolating said plateletlike particles having said polymeric coating layer from the suspension; and
(e) heating said plateletlike particles having said polymeric coating layer to a temperature of from 100° C. to 1000° C. in a gaseous environment.

2. The process according to claim 1, wherein the one or more polymers are selected from polyvinylpyrrolidone, polyacrylonitrile, polyaniline and polyurethane.

3. The process according to claim 2, wherein the polymer is polyacrylonitrile having a weight average molecular weight of 50,000 to 200,000.

4. The process according to claim 1, wherein the liquid is dimethyl acetamide (DMAC) and/or N,N′-dimethyl formamide (DMF).

5. The process according to claim 2, wherein the polymer is polyvinylpyrrolidone having a weight average molecular weight of 50,000 to 80,000.

6. The process according to claim 5, wherein the liquid is water.

7. The process of claim 1, wherein plateletlike particles are heated in step e) to a temperature of from 200-600° C.

8. A platelet-like pigment comprising a core and at least one coating layer said coating layer consisting essentially of a compound having from 60 to 95% by weight of carbon and from 5 to 25% by weight of nitrogen, the balance to 100% being selected from elements of the group consisting of hydrogen, oxygen and sulphur, obtained according to the process of claim 1.

9. (canceled)

10. Paints, printing inks, plastics, cosmetics, ceramics or glass, which are pigmented with a pigment according to claim 8.
